(19) United States
(12) Patent Application Publication
(10) Pub. No.: US 2020/0229446 A1
(43) Pub. Date: Jul. 23, 2020

(54) Cacti and Cacti Parts for Use as Pesticides, Fertilizers and Regeneration and Growth Enhancers of Plants

(71) Applicant: Isaak HAYIK, Yehud (IL)

(72) Inventor: Isaak HAYIK, Yehud (IL)

(21) Appl. No.: 15/755,560

(22) PCT Filed: Sep. 12, 2016
(86) PCT No.: PCT/IL2016/051017

§ 371 Date: Feb. 27, 2018

Related U.S. Application Data
(60) Provisional application No. 62/210,633, filed on Aug. 27, 2015.

(30) Foreign Application Priority Data
Aug. 27, 2015 (IL) 240896

(51) Int. Cl. A01N 65/08; C05F 11/00

(52) U.S. Cl. CPC A01N 65/08; C05F 11/00

(57) ABSTRACT

Mixtures of and methods utilizing cacti and cacti parts such as leaves, stalk, stump and fruit skin are used to fertilize all types of cultivated and wild plants and as organic pesticides. Such mixtures and methods are also used to rejuvenate, regenerate, enhance and regulate growth in plants based on cacti plant and parts of cacti plant. Particularly, these materials and methods use the content of elliptical stalks, thorny leaves (opuntia) growing out of the stalks and skins of cacti fruits for fertilizing and rehabilitating plants and as pesticides under moderate or harsh climates or conditions of growth.

### TECHNICAL FIELD

The present invention pertains to fertilizers, pesticides and regeneration and growth enhancers of plants based on cacti plants, and more particularly on the cactus species of Opuntia ficus-indica.

### BACKGROUND

The use of fertilizers based on natural ingredients or products of biological activity of animals for cultivated plants is well-known in the art. Such naturally-based fertilizers provide plants with basic nutrients and minerals from natural sources and reduce the use of synthetic chemicals that may pass further in the food chain to consumers as humans and livestock. However, such natural fertilizers do not eliminate the need for synthetic pesticides such as phosphorous-based compounds, which are considered toxic, leaving traces down the food chain and causing negative side-effects to consumers of the plants or plant fruits. Genetically engineered plants with built-in resistance to pests, insects, insect exudates, fungi, bacteria and parasites are considered the most current but controversial solution, which is not yet fully developed. The alleged negative implications of genetically modified plants on human health and naturally grown plants and wildlife are yet to be explored. However, naturally based fertilizers and pesticides seem to provide a positive solution that eliminates such concerns.

Cacti plants have long been studied for their therapeutic effect in different medical conditions and disorders in humans and livestock and as effective, natural-based and free of negative side-effects substitutes for synthetic antibiotics. Such species of plant is appreciated for its high capacity of water, endurance under severe climate conditions and ability to survive and provide for itself the nutrients and minerals it needs for growth and protection from different types of parasites. Cacti extracts have also shown positive effect in regulating physiological and biochemical systems in the human body including lowering cholesterol levels in the bloodstream, balancing amounts of sugar in the blood, enhancing blood clotting by improving activity of blood pellets, treating ulcer, glaucoma, liver malfunctions such as cirrhosis, asthma, shortness of breath, urinary retention, chronic fatigue, improving motility in bowls and gastro-intestinal tract, inter-neuron communication, heart muscle function, healing wounds and assisting in building skeletal bones. The use of cacti and cacti parts for fertilization and regulation of plant growth, therefore, shows the importance of the invention detailed below.

It is, therefore, an object of the present invention to fulfill the need for materials and methods based on cacti and cacti parts for providing plants with a good source of nutrients and minerals and at the same time efficient resistance to pests, insects, insect exudatess, fungi, bacteria and parasites.

It is yet another object of the present invention to provide materials and methods based on cacti and cacti parts for rejuvenating, enhancing and regulating growth of plants and improving quality and increasing quantity of products of plants.

This and other objects of the present invention shall become apparent as the description proceeds.

### SUMMARY

The present invention pertains to materials and methods for fertilizing, rejuvenating, regenerating, enhancing and regulating growth in plants based on cacti plant and parts of cacti plant. Particularly, the materials and methods of the present invention use the elliptical stalks, thorny leaves (opuntia) growing out of the stalks and skins of cacti fruits. Most particularly, the cacti parts are taken from a particular type of cactus plant entitled Opuntia ficus-indica, which can be found in southern parts of America, Spain and the Middle East including Israel. The fleshy stalks of the Opuntia ficus-indica contain substantial amounts of gelatin material composed mainly of water and serving as a medium for nutrients, minerals such as magnesium, zinc, potassium, calcium, iron, and selenium, vitamins, natural fibers such as pectin, and other compounds and materials.

The following table summarizes the various materials and amounts per 100 gr found in fruits of Opuntia ficus-indica:

| | Amount | |
|---|---|---|
| Nutrient | (per 100 gr) | |
| Calories | 41 | Kcal |
| Proteins | 0.73 | g |
| Carbohydrates | 9.57 | g |
| Fats | 0.51 | g |
| Saturated Fat | 0.067 | g |
| Cholesterol | 0 | |
| Sodium | 5 | mg |
| Fibers | 3.6 | g |
| Water | 87.55 | g |
| Vitamin A | 2 | μg |
| Vitamin B (total) | 0.6 | mg |
| Vitamin B1 | 0.014 | mg |
| Vitamin B2 | 0.06 | mg |
| Vitamin B3 - Niacin | 0.46 | mg |
| Vitamin B6 | 0.06 | mg |
| Folic acid (Vitamin B9) | 6 | μg |
| Vitamin C | 14 | mg |
| Calcium | 56 | mg |
| Iron | 0.3 | mg |
| Magnesium | 85 | mg |
| Phosphorus | 24 | mg |
| Zinc | 0.12 | mg |
| Potassium | 220 | mg |
| Fatty acids (multi- non-saturated) | 0.213 | g |
| α-Linolenic acid (Omega 3) | 0.023 | g |
| Linoleic acid (Omega 6) | 0.186 | g |
| Fatty acids (non-saturated) | 0.075 | g |
| Oleic acid (Omega 9) | 0.072 | g |

The table above exemplifies the potency of the Opuntia ficus-indica plant and hence their potential as super-fertilizers for re-growth and regeneration.

In one aspect, the present invention provides a method for fertilizing, regenerating and enhancing the growth of plants with regular administration of all or part of cactus plant of the type Opuntia ficus-indica. Specifically, the present invention provides administration regimen of different parts of Opuntia ficus-indica for recovery of cultivated plants, farm plants, wild plants, garden plants, herbals, flowers, flower shrubs and any other type of plant in any state of growth or decay. Such regimen may comprise several steps as exemplified in the following procedure:

A group of mature trees, with varying ages, some planted already in 1978, were selected for fertilizing with the skin of Opuntia ficus-indica fruits. Younger and new plants were selected as control group for the mature plant group. Both mature and younger trees were selected from fruit trees of Avocado, Lemon, Tangerine and other citrus trees, Vine, Fig, Mango, Palm tree and also ornamental trees.

The season of fruit picking starting on August (2013 in this particular example) through October was selected for the trial.

Fresh fruits of Opuntia ficus-indica were picked from plants growing in Israel at different locations without particular or enhanced conditions of growth and without irrigation. The fruits were peeled off and their skins accumulated to quotas of approximately 4 to 5 kg each. The fruits skins in each quota were fresh and distributed in the plant bed of every mature plant throughout the period of time mentioned above between August and October, 2013.

The younger and new plants were fertilized with regular compost obtained from a plant nursery.

The fruit skins were then mixed with the soil in the plant bed of the mature trees and the soil was then watered.

Both groups of plants were watered with water amounts, which were regular for that particular season. Hose or droppers were used to water the plants 2 to 3 times a week for about 40 minutes every time.

The skins initiated a process of decay, darkened, decomposed and released their content into the soil within the first 10 days of the trial.

Results were observed in the following season: Growth of the mature plants was doubled relative the preceding season and the amount of fruits produced was doubled for every tree and every species of tree as well. Older vine in the group of mature trees showed surprising, unexpected rejuvenation and growth after 20 years of dormancy.

In a further exemplary procedure, grounded spiny stalks of Opuntia ficus-indica were added to the fruit skins and the mixture distributed in the soil of the mature trees beds.

In another example of administration regimen of a mixture of parts of Opuntia ficus-indica, tree beds of two young, three years old avocado trees suffered attacks of sooty molds (a type of fungus) on their leaves and other different pests, while treated with customary compost. Usually sooty mold thrives on a white powdered sticky layer, which is formed of plant exudates and the sugary honeydew secreted by insects such as aphids, scales, the whitefly, and other insects which suck sap from their host plants. The avocado trees were then treated with fresh skins of fruits and grounded spiny stalks of Opuntia ficus-indica over a period of time similar to that in the regimen described above.

The infected leaves of the avocado trees turned brown and eventually fell and new fresh leaves grew in their place in a period of time of less than 6 months.

It is currently assumed that the particular combination of natural nutrients, minerals and other active compounds in the mixture of fruit skins and stalks of Opuntia ficus-indica provided the plants with enhanced resistance to pests after filtrating the soil and then diffusing into the trees roots. Such combination of chemicals enabled the avocado trees to counteract the negative effect of sooty mold and other pests on the leaves and initiate regeneration and growth.

Pesticide sprays based on synthetic chemical compounds, for example compounds containing lethal phosphorous, are currently considered to adversely affect anyone coming in contact with them even when trace amounts are involved. Accordingly, they are considered not healthy to the farmer potentially exposed to them by inhalation in the open field or in a greenhouse, the soil, the plants and finally the consumers. On the other hand, use of organic spray based on extracts of Opuntia ficus-indica, may substantially eliminate negative side-effects related to synthetic pesticides. Therefore, in another aspect of the present invention, another administration regimen may be contemplated by directly spraying infected leaves and stump of a plant with a spray that comprises extracts of fruit skins and stalks of Opuntia ficus-indica in regular intervals of time. Such direct spraying may contact the active compounds in the Opuntia ficus-indica spray with the fungi, and pests inhabiting the leaves and stump of a plant as well as insects and insect exudates and result in instant pesticidal effect without adversely affecting other parts of the plant or its vitality. Similar healing process may be observed with first decay, decomposition and fall of the infected leaves and growth of fresh new leaves in their place.

In still another aspect, regular administration of fresh parts of Opuntia ficus-indica, particularly fruit skins and stalks, enhance the natural resistance of plants to different types of pests, fungi, insects, insect exudates, parasites and bacteria, particularly those previously treated and eliminated. Accordingly, the natural resistance of the plants fertilized with Opuntia ficus-indica may improve in the long-term to pests, fungi, insects, insect exudates, parasites and bacteria even when fertilization is stopped.

Although, fruit skins and stalks of Opuntia ficus-indica are provided in their fresh, natural and raw state for plant and soil fertilization, preservation conditions, such as temperature and moisture may apply for future use. For example, the skins and stalks may be refrigerated in moist atmosphere to maintain their freshness over time. Alternatively, they may be dried or freeze-dried, grounded and preserved in a sealed vacuum container or bag. In still a third alternative, fresh fruit skins and stalks of Opuntia ficus-indica may be processed to preserve the valuable nutrients they contain, for example by extraction or exudation of the liquid and gelatin and its content and preservation in appropriate conditions.

In view of the above, the present invention provides in still another aspect, compositions for fertilizing plants, enhancing growth of plants, regenerating growth in dormant plants, enhancing plants resistance to pesticides, fungi, parasites, insects, insect exudates and bacteria and increasing productivity of plants. In one particular embodiment, such compositions may be provided in liquid form, as spray or solid compost based on grounded fruit skins, stalks, stump and other parts of Opuntia ficus-indica.

In view of the above, the present invention provides a method for increasing potency of a plant, the method comprising:
(a) obtaining plants of Opuntia ficus-indica in a picking season;
(b) picking fruits of the Opuntia ficus-indica and peeling off skins of the fruits;
(c) cutting off stalks of the Opuntia ficus-indica and grinding the stalks;
(d) mixing together the fruit skins and grounded stalks;
(e) distributing the mixture formed of the fruit skins and grounded stalks on the plant bed, mixing the mixture with the soil in the plant bed and watering;
(f) repeating steps (a)-(e) for a prescribed period of time or until observing positive response of the plant to the mixture.

The method as detailed above is suitable for encouraging, rejuvenating, regenerating or enhancing growth of the plant, eliminating pathogenic effects caused by pests, parasites, insects, insect exudates, fungi and bacteria hosted by the plant and negative effects thereof and increasing potency and productivity of the plant.

In still another aspect, the present invention provides a mixture of parts of Opuntia ficus-indica that comprise fresh skins of fruits and grounded spiny stalks and leaves of Opuntia ficus-indica. This mixture is suitable for administration to plants for encouraging, rejuvenating, regenerating or enhancing growth of plants, eliminating pathogenic effects caused by pests, parasites, insects, insect exudates, fungi and bacteria hosted by these plants and negative effects thereof and increasing potency and productivity of the plants.

In still another aspect, the present invention provides a spray that comprises extract of fresh fruit skins, spiny stalks and leaves of Opuntia ficus-indica. This extract comprises particular combination of nutrients, minerals and active compounds and is suitable for spraying on leaves, branches and stump of plants for encouraging, rejuvenating, regenerating or enhancing growth of these plants, eliminating pathogenic effects caused by pests, parasites, insects, insect exudates, fungi and bacteria hosted by the plants and negative effects thereof and increasing potency and productivity of the plants.

In still another aspect, the present invention provides compost that comprises soil and mixture of parts of Opuntia ficus-indica. The mixture comprises fresh skins of fruits and grounded spiny stalks and leaves of the Opuntia ficus-indica. The compost is suitable for administration to plants for encouraging, rejuvenating, regenerating or enhancing growth of the plants, eliminating pathogenic effects caused by pests, parasites, insects, insect exudates, fungi and bacteria hosted by the plants and negative effects thereof and increasing potency and productivity of the plants.

The mixture and method of the present invention are essentially suitable for treatment of all types of plants, particularly plants selected from cultivated plants and wild plants.

The cultivated plants practically pertain to all types of crops grown for consumption by humans or cultivated livestock and pets. Particular cultivated plants comprise fruit trees, farm plants, herb plants, garden plants, greenhouse plants, vegetable plants, but also flowers and flower shrubs and ornamental trees.

Fruit trees that suitable for treatment with the mixture of the present invention comprise vine, palm, fig, avocado, lemon, pomelo and other citrus trees, mango, apple, apricot, peach, cherry, strawberry, carob, almond and walnut.

The mixture of the present invention may also be use in large scales where the crops occupy vast areas of land. Such may be selected from wheat, corn, rice, barley, sorghum, millet, oats, rye, triticale, buckwheat, fonio, bean, lentil, peanut and quinoa.

Type of plants suitable for treatment with the mixture of the present invention, which are usually grown as garden plants, greenhouse plants or large scale vegetable plants may comprise tomato, onion, cucumber, carrot, cubage, potato, lettuce, turnip, kohlrabi, garlic, cauliflower and sunflower.

Further to the types of crops and plants detailed above, the Opuntia ficus-indica is also suitable for fertilizing and as organic pesticide for plants growing or grown in desert and desert climate. This capability of Opuntia ficus-indica essentially stems from the fact that the it has developed extremely efficient survival and resistance qualities under drought conditions with minimal supply of water and nutrients.

It is, therefore, clear that the present invention has a potential for affecting methods and perspectives in global agriculture and world economy.

The following will describe particular and non-limiting examples of the present invention with reference to the drawings without departing from the scope and spirit of the present invention.

### BRIEF DESCRIPTION OF THE DRAWINGS

FIGS. 1A-C demonstrate regeneration and growth of decaying avocado tree treated with the materials of the present invention.

FIGS. 2A-C shows another demonstration of regeneration and growth of decaying avocado tree treated with the materials of the present invention.

FIG. 3 demonstrates regeneration and oversize growth of citrus pomelo tree treated with the materials of the present invention.

FIGS. 4A-C demonstrate different stages of fertilizing trees with the materials of the present invention.

FIGS. 5A-B demonstrate revival of dormant fig tree treated with the materials of the present invention.

FIGS. 6A-C demonstrate rehabilitation of palm trees and revival of dormant vine treated with the materials of the present invention.

FIGS. 7A-C demonstrate revival of dormant mango tree and thriving of different plants and herbals treated with the materials of the present invention.

FIGS. 8A-B demonstrate survival potency of Opuntia ficus-indica under harsh conditions.

### DETAILED DESCRIPTION OF THE DRAWINGS

The following relates to the photos displayed in the Figures and the evidence they present for the positive effect of fertilizing different types of plants with parts of Opuntia ficus-indica. It should be noted that these photos only exemplify the potency of fertilizing with Opuntia ficus-indica and that similar or better results of plant regeneration, rejuvenation, revival, increased productivity and resistance to pesticides may be obtained with other types of plants, regimens of fertilizing plants and types of plants. Further examples of rejuvenation and growth of plants fertilized with Opuntia ficus-indica are evidenced in the inventor premises.

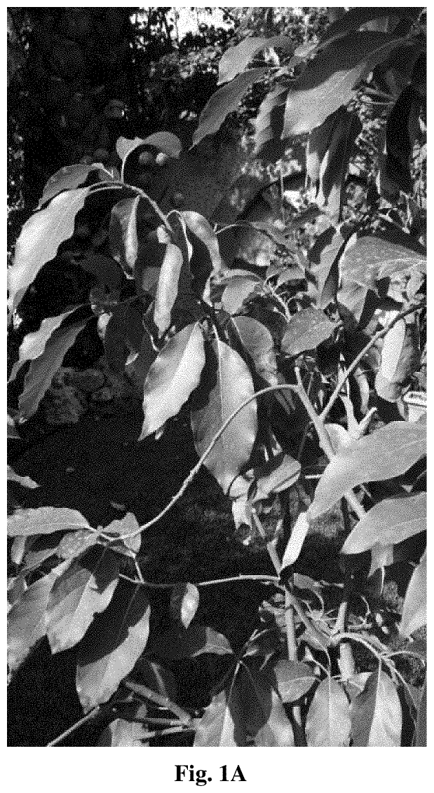

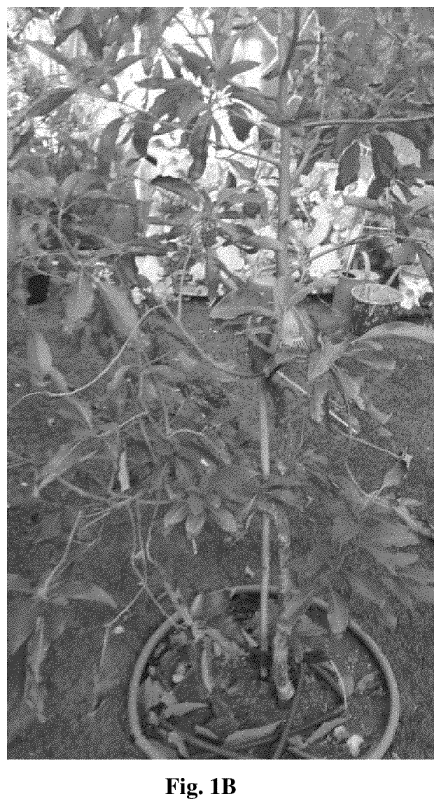

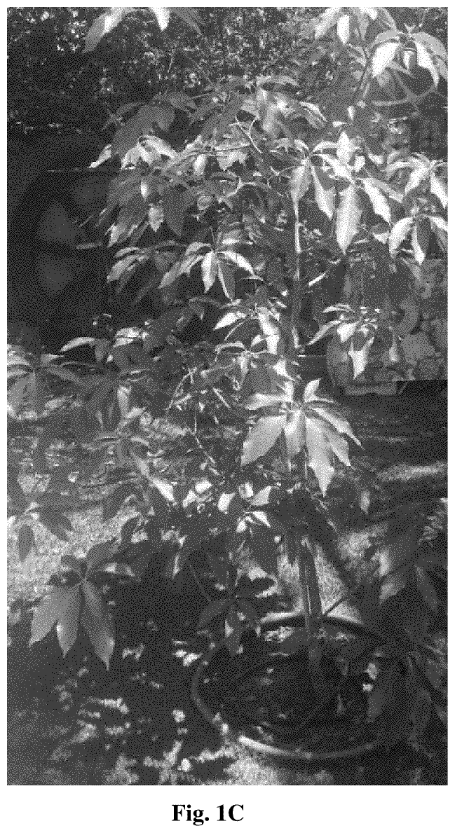

FIGS. 1A-C demonstrate the effect of fertilizing avocado tree infected with sooty mold and other parasites and pests with parts of Opuntia ficus-indica. FIG. 1A is a close-up on infected leaves of the avocado tree taken on Jul. 12, 2014. The photo in FIG. 1A shows the infected leaves turning yellow at their center and brownish at their margins due to the sticky layer of sooty mold that covered them and blocked sun rays from reaching the leaves and initiate photosynthesis. The photo in FIG. 1B was taken on Sep. 3, 2014 before spreading parts of Opuntia ficus-indica on the tree bed. Evidently, the leaves in FIG. 1B deteriorated further turning brown and crumbling, many of them falling off of the avocado tree and accumulating as dead leaves on the tree bed. A mixture of fresh parts of Opuntia ficus-indica including fresh skins fruits and grounded spiny stalks was then prepared and distributed on the tree bed in the vicinity of the stump and above its roots. The soil in the plant bed was turned over together with the mixture and watered. The photo in FIG. 1C was taken on May 1, 2015 after regular fertilization of the avocado tree with the mixture spread over the period of time between Sep. 3, 2014 and May 1, 2015. The tree was watered regularly every time a quota of the mixture was distributed on the tree bed. This photo shows a healthy avocado tree with freshly grown wide, green leaves absent of any cover of white dust or any other symptoms suggesting the presence of parasites.

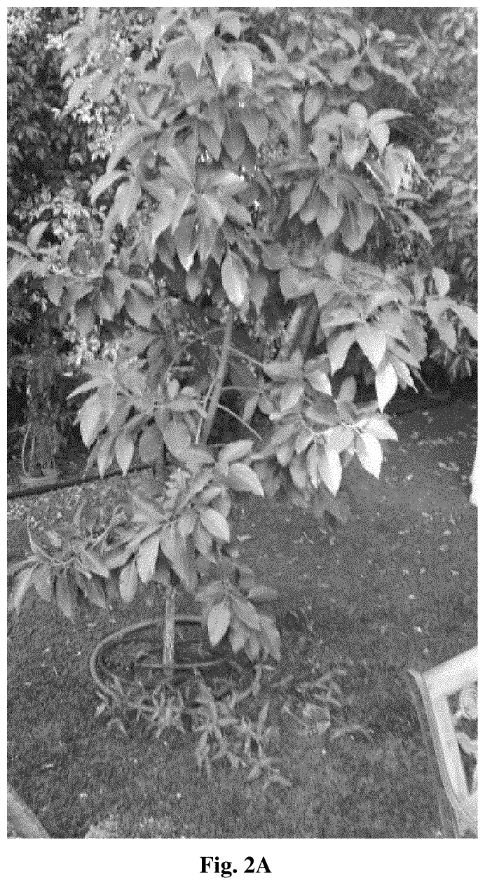

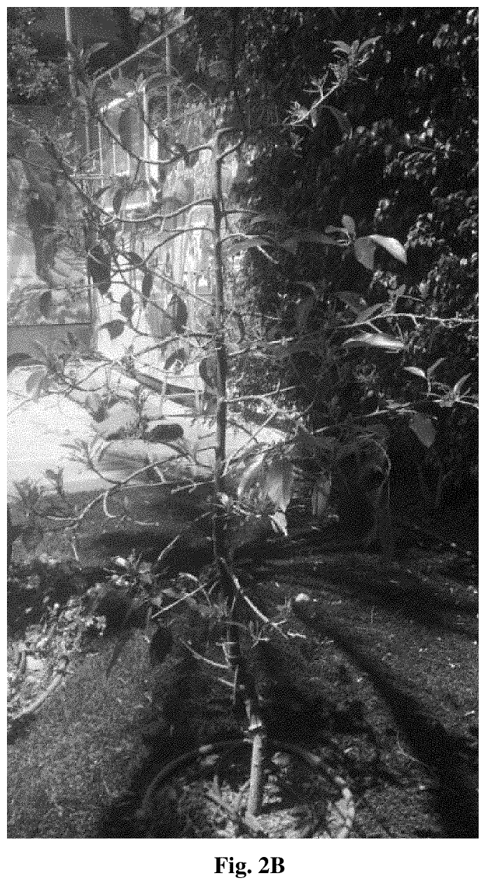

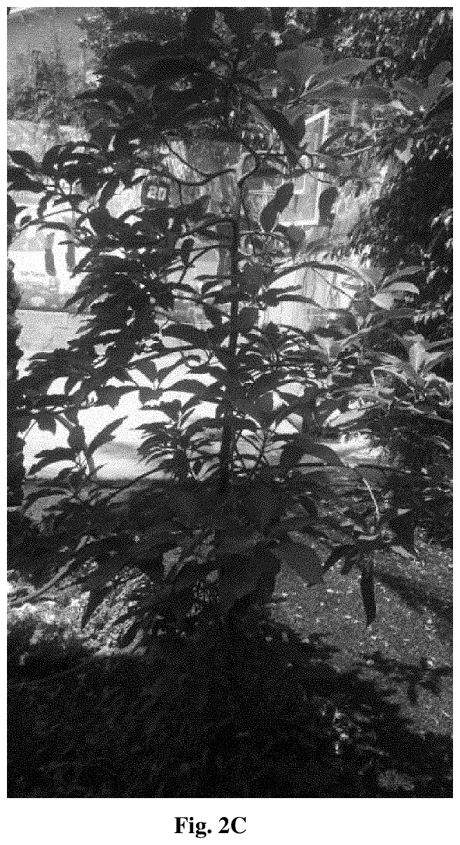

FIGS. 2A-C display another example of an avocado tree treated with a mixture of different parts of Opuntia ficus-indica, particularly, fresh fruit skins and grounded spiny stalks. The photo in FIG. 2A was taken on Sep. 18, 2014 and shows a severely sick avocado tree in infected progressing stage with sooty mold and other parasites. The entire foliage of the tree was in advanced stage of discoloration turning whitish-gray. The tree was treated with quotas of a mixture of parts of Opuntia ficus-indica, particularly fresh fruit skins and grounded spiny stalks, distributed on the tree bed, mixed with the soil and watered over a period of time between Sep. 18, 2014 and May 1, 2015. The photo in FIG. 2B shows the same avocado tree after regular administration with the mixture. The photo was taken on May 1, 2015 showing a relatively sparse but healthy foliage, which is a result of the first stage of healing and rejuvenation in which the sick leaves continued their process of decay until complete falling of the foliage. First signs of growth of healthy leaves are displayed in FIG. 2B showing fresh, wide, green leaves that grew in place of the falling sick ones. FIG. 2C shows the same avocado tree about two months later with full, healthy foliage absent of any signs of sooty mold and any other parasite hosted by the tree. The photo in FIG. 2C was taken on Jun. 24, 2015.

The two avocado trees shown in FIGS. 1A-C and 2A-C exemplify the unique process of recovery encouraged by the administration of the mixture of the present invention. Such process includes first accelerating the discarding of the sick parts of the tree, then instigating healthy growth. In this respect, the parts of Opuntia ficus-indica used do not just fertilize the trees with necessary nutrients and minerals they need for healthy growth as ordinary compost does, but rather regulate the entire circulation within the trees. It is assumed that the gradual decomposition of the parts of Opuntia ficus-indica into the soil and diffusion of unique combination of materials they contain into the trees roots are responsible for the process of accelerated decay and recovery of plants displayed in the present invention. One should note that such unique combination of materials enables Opuntia ficus-indica itself to survive under extreme climate conditions and attacks of parasites. This may have, therefore, forced Opuntia ficus-indica to develop particular resistance to climate and natural or infection-induced decay processes. Such resistance may be expressed in the unique combination of materials its parts contain. When such combination is integrated within the sick trees it enhances the resistance of the trees and reorganizes their response to different types of attacks on and abuse of their resources, foliage, stalks, branches, stumps and fruits. As a result, the trees develop improved resistance to attack, which expresses in intensified growth and productivity beyond their normal potential.

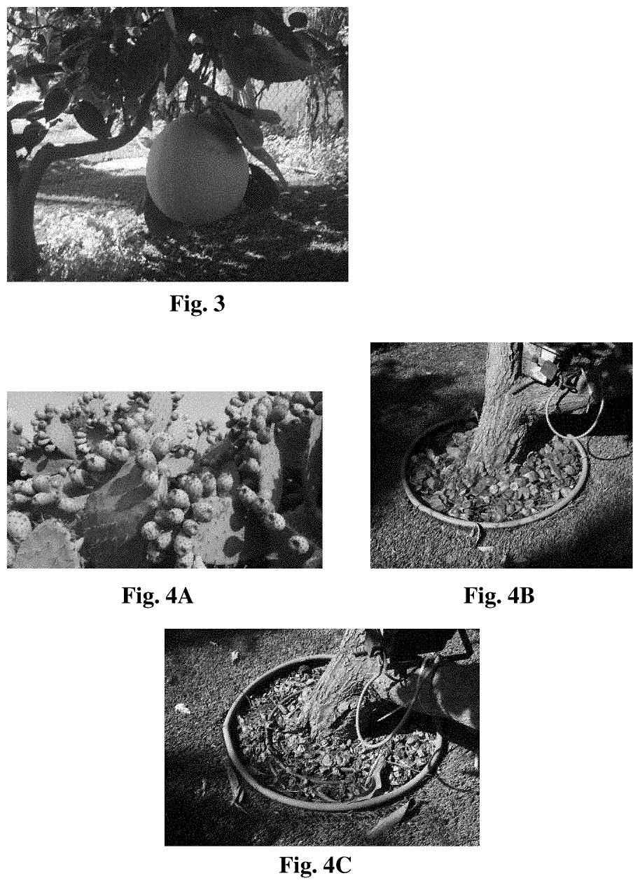

FIG. 3 displays excellent example of above normal ultra super-size growth in response to treatment with the mixture of the present invention. Citrus maxima tree, aka pomelo tree, produced fruit with huge size after continuous treatment with a mixture of parts of Opuntia ficus-indica, particularly fruit skins and grounded spiny stalks. The tree itself grew at about 50% its original size in a period of time of two years. The picture of the pomelo tree and fruit was taken on Feb. 27, 2015.

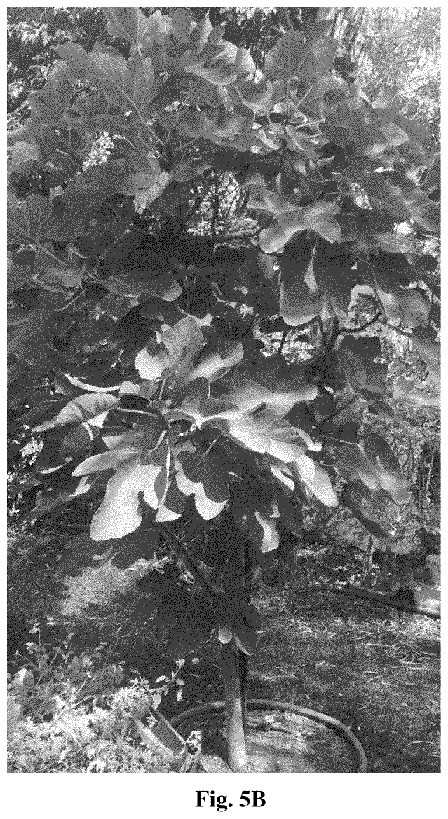

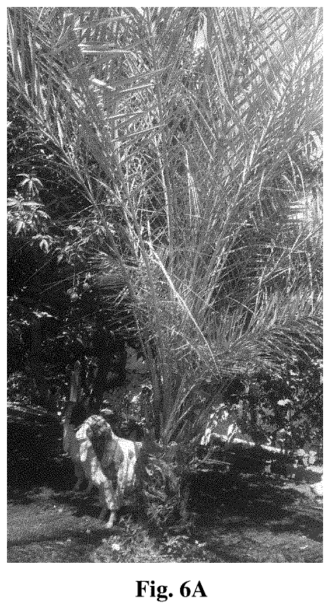

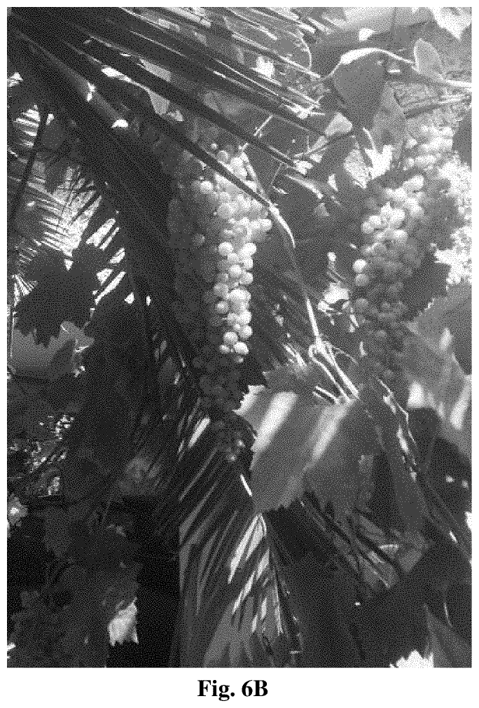

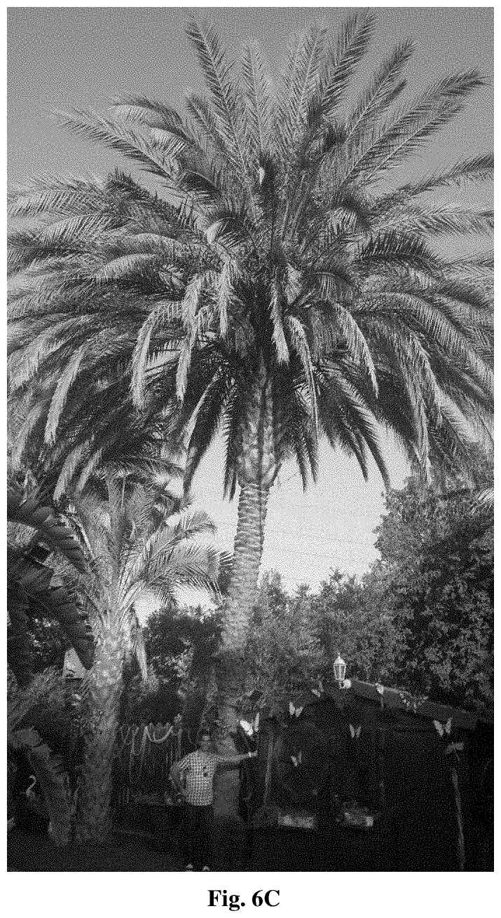

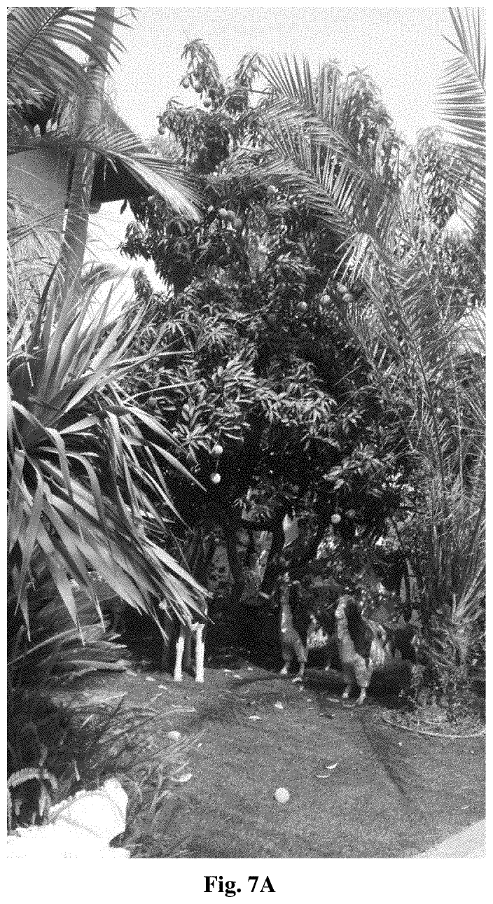

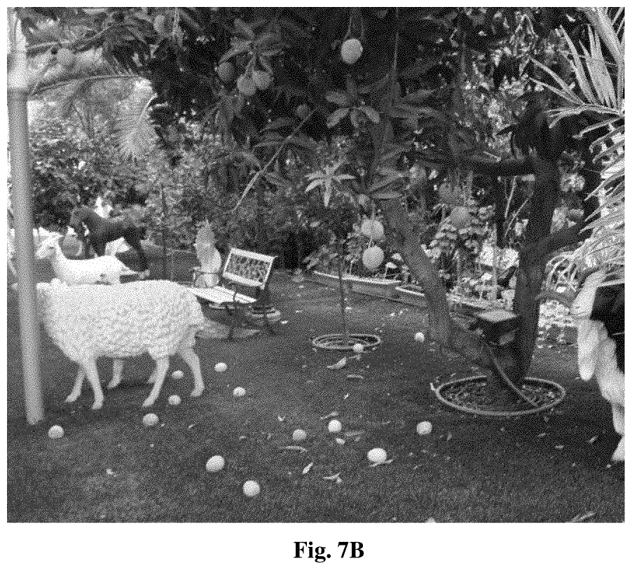

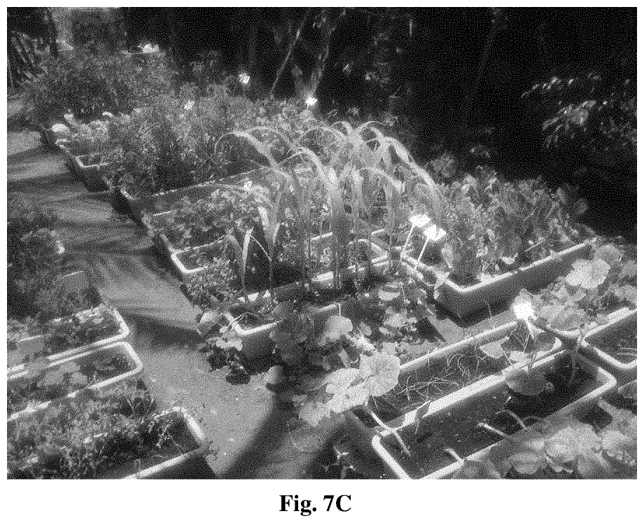

The positive response to the administration of the mixture of the present invention further expresses in revival of dormant plants. FIGS. 5A-5B, 6B and 7A-7B display extremely surprising results in dormant vine, fig, palm and mango trees that renewed their growth and productivity after substantial period of time of dormancy. FIGS. 5A-5B show a fig tree revived after eight years of dormancy. FIG. 5A shows the dormant fig tree before being treated with a mixture of the present invention that comprised fresh fruit skins and grounded spiny stalks of Opuntia ficus-indica. The photo was taken on Jul. 18, 2013, showing a relatively small number of leaves and branches, particularly fresh ones. The same fig tree is shown in the photo in FIG. 5B taken on May 26, 2015 after two seasons of fertilization with a mixture of the present invention. Clearly, the fig tree shows increased amount of fresh larger than normal size foliage and branches. The amount of fruits produced was doubled as well. The photo in FIG. 6B shows the revival of vine after 32 years of dormancy and one season of treatment with a mixture of the present invention. The vine rejuvenated growth of leaves and branches and produced substantial amount of fruits. FIGS. 7A-B also show the revival of mango tree after 32 years of dormancy. Above normal growth of plants fertilized with a mixture of the present invention is displayed in the photos in FIGS. 7A-B taken on Aug. 10 and 30, 2014, respectively. These photos show the growth of the tree to height above 6.8 meters after two years of treatment with a mixture of the present invention. The amount of fruit of the mango tree was doubled within one year.

FIG. 6A exemplifies the super-positive effect of treatment of plants with a mixture of the present invention on a young palm tree. The tree size increased more than a third its original size within two years of treatment. The photo taken on Jun. 24, 2015 shows that mixture of the present invention intensifies growth of plants of any age and practically any species. FIG. 7C is another example of enhanced growth of vegetable and herbal plants treated with a mixture of the present invention. FIG. 6C presents another perspective on the healing effect of the mixture of the present invention. A 25 year old palm tree suffered constantly from pathogenic effects caused by pests, parasites, insects and the like. Conventional continuous treatment with synthetic fertilizers and pesticides supervised by an expert scientist for palm trees, running lab experiments focusing on pests and plant fertilization, did not produce results and the palm tree continued to suffer from infestation and diseases. The conventional treatment was eventually ceased and the palm tree was fertilized with the mixture of the present invention of fruit skins and grounded stalks and leaves of Opuntia ficus-indica for a period between two to three years. The result is evident from the photo in FIG. 6C. The palm tree discarded the pathogenic diseases that attacked it and presented substantial and healthy growth and productivity.

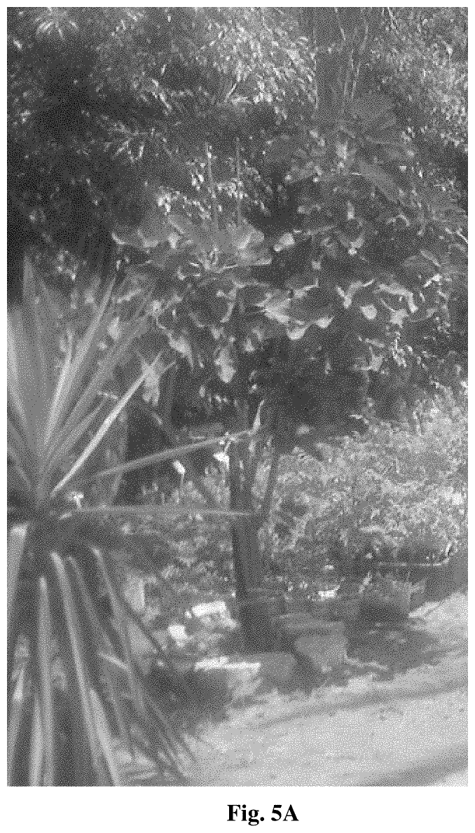

FIGS. 4A-C show the different stages of the fertilization with Opuntia ficus-indica. Fresh fruits and stalks of Opuntia ficus-indica were harvested, the fruit skins were peeled off and the stalks grounded. The mixture was distributed on the tree or plant bed as shown in FIG. 4B mixed with the soil and watered. It was then let to decay and decompose into the soil around the plant (see FIG. 4C). The nutrients and minerals were absorbed in the soil, diffused into the plant roots, filtrated up the stump and dispersed in the plant circulation. It is currently assumed that the minerals, nutrients and other compounds and elements present in the mixture concentrated mainly in parts and areas within the plant where shortage thereof was experienced or where they were most required for proper function of the plant. Accordingly, regular provision of the mixture rehabilitated the plant circulation and enhanced capacities such as resistance to parasites, growth and production of fruits. Further it is believed that Opuntia ficus-indica developed unique survival capacity under severe conditions of hot and dry climate with large temperature swings between day and night and hostile environment including animals and parasites attempting to exploit its resources for their own survival. Therefore, it is believed that the administration of a mixture of parts of Opuntia ficus-indica according to the present invention imparts improved and/or enhanced properties to plants grown in moderate climate. This super-potency of the treated plants essentially expresses in super-size fruits and leaves and above normal growth of the plant dimensions.

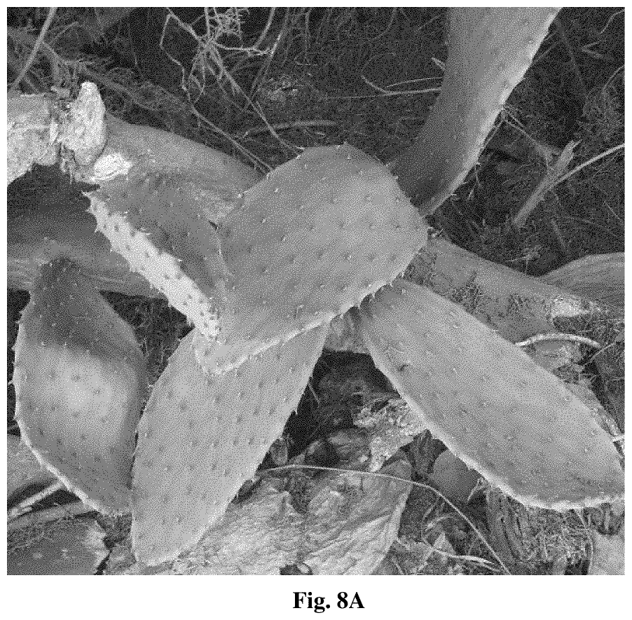

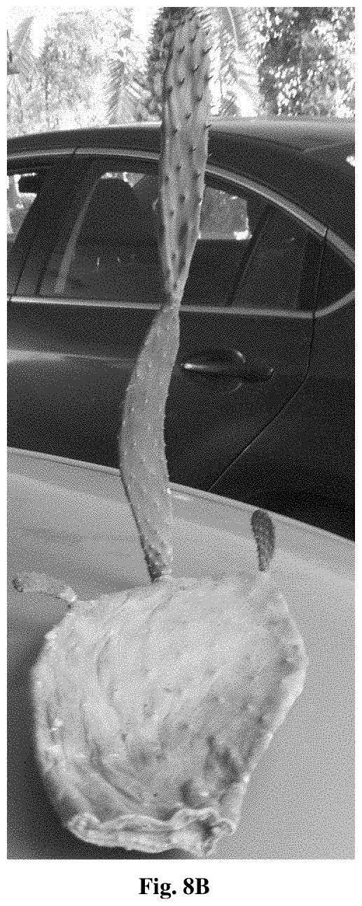

The survival potency of Opuntia ficus-indica is observable from FIGS. 8A-B showing photos of fresh new stalks of Opuntia ficus-indica growing out of dry dead stump (FIG. 8A) or without direct watering, contact with soil or provision of nutrients and minerals (FIG. 8B). Regarding FIG. 8A, all vital nutrients and minerals were kept in hibernation conditions in the stump, similar to dried solid extract of water-containing organic solutions. A revival mechanism imprinted in the stump enabled it to initiate circulation of the nutrients, minerals and other materials combined with whatever humidity it was able to absorb from the surrounding air. Accordingly, growth of a new leaf followed, which exploited the dried natural reserves in the stump to produce a fresh resource for further production and accumulation of nutrients and minerals. The Opuntia ficus-indica, therefore, is essentially capable of enhancing itself under extremely difficult survival conditions and even when cut-off from life sustaining resources such as water and nutrients direct sources. Providing at least part of such potency of Opuntia ficus-indica to other plants, particularly plants unsuccessful in fighting back parasites or lacking sufficient strength to rejuvenate or grow, imparts them the capacity to activate such capabilities under moderate, more comfortable climate conditions above and beyond their basic potential.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

1. A method for increasing potency in a plant, said method comprising:
(a) obtaining plants of Opuntia ficus-indica;
(b) picking fruits of said Opuntia ficus-indica and peeling off skins of said fruits;
(c) cutting off stalks of said Opuntia ficus-indica and grinding said stalks;
(d) mixing together said skins of said fruits and grounded stalks;
(e) distributing mixture of said skins of said fruits and grounded stalks on bed of said plant, mixing said mixture with soil in said plant bed and watering;
(f) repeating steps (a)-(e) for a prescribed period of time or until observing positive response of said plant to said mixture, wherein
said method is suitable for encouraging, rejuvenating, regenerating or enhancing growth of said plant, eliminating pathogenic effects caused by pests, parasites, insects, insect exudates, fungi and bacteria hosted by said plant and negative effects thereof and increasing potency and productivity of said plant.

2. The method according to claim 1, wherein said mixture is provided in discrete quotas, said distributing comprises administration regimen of said quotas in regular time intervals during winter and spring seasons, said quotas accumulating to a total of 4 to 5 kg of said mixture per plant.

3. The method according to claim 1, wherein said plant is selected from cultivated plants and wild plants.

4. The method according to claim 3, wherein said cultivated plants comprise fruit trees, farm plants, herb plants, garden plants, greenhouse plants, vegetable plants, flowers and flower shrubs and ornamental trees.

5. The method according to claim 4, wherein said fruit trees comprise vine, palm, fig, avocado, lemon, pomelo and other citrus trees, mango, apple, apricot, peach, cherry, strawberry, carob, almond and walnut.

6. The method according to claim 4, wherein said farm plants comprise wheat, corn, rice, barley, sorghum, millet, oats, rye, triticale, buckwheat, fonio, bean, lentil, peanut and quinoa.

7. The method according to claim 4, wherein said garden plants, greenhouse plants and vegetable plants comprise tomato, onion, cucumber, carrot, cubage, potato, lettuce, turnip, kohlrabi, garlic, cauliflower and sunflower.

8. The method according to claim 4, wherein said cultivated or wild plants are grown in desert, desert climate or drought conditions with minimal supply of water and nutrients.

9. The method according to claim 1, wherein response of said plant expresses in above normal growth of said plant and above normal size and quantity of fruits of said plant.

10. The method according to claim 1, wherein said plant is in state of dormancy, said mixture is suitable for rejuvenating said plant in state of dormancy.

11. The method according to claim 10, wherein period of time of said dormancy of said plant spans between 8 and 32 years.

12. The method according to claim 1, wherein said plants of Opuntia ficus-indica are harvested in all seasons throughout the year.

13. The method according to claim 1, wherein said fruits are picked during picking season.

14. A mixture of parts of Opuntia ficus-indica comprising fresh skins of fruits and grounded spiny stalks and leaves of said Opuntia ficus-indica, said mixture is suitable for administration to plants for encouraging, rejuvenating, regenerating or enhancing growth of said plants, eliminating pathogenic effects caused by pests, parasites, insects, insect exudates, fungi and bacteria hosted by said plants and negative effects thereof and increasing potency and productivity of said plants.

15. The mixture according to claim 14, wherein said administration comprises administration regimen spread over winter and spring seasons, said mixture is divided to quotas provided to said plants at regular time intervals, said quotas accumulate to 4 to 5 kg per plant.

16. The mixture according to claim 14, wherein said plant is selected from cultivated plants and wild plants.

17. The method according to claim 16, wherein said cultivated plants comprise fruit or ornamental trees, farm plants, herb plants, garden plants, greenhouse plants, vegetable plants, flowers and flower shrubs.

18. The mixture according to claim 17, wherein said fruit trees comprise vine, palm, fig, avocado, lemon, pomelo and other citrus trees, mango, apple, apricot, peach, cherry, strawberry, carob, almond and walnut.

19. The mixture according to claim 17, wherein said farm plants comprise wheat, corn, rice, barley, sorghum, millet, oats, rye, triticale, buckwheat, fonio, bean, lentil, peanut and quinoa.

20. The mixture according to claim 17, wherein said garden plants, greenhouse plants and vegetable plants comprise tomato, onion, cucumber, carrot, cubage, potato, lettuce, turnip, kohlrabi, garlic, cauliflower and sunflower.

21. The mixture according to claim 16, wherein said cultivated or wild plants are grown in desert, desert climate or drought conditions with minimal supply of water and nutrients.

22. The mixture according to claim 14, wherein response of said plants expresses in above normal growth of said plant and above normal size and quantity of fruits of said plant.

23. The mixture according to claim 14, wherein said plant in state of dormancy, said mixture is suitable for rejuvenating said plant in state of dormancy.

24. The mixture according to claim 23, wherein period of time of said dormancy of said plant spans between 8 and 32 years.

25. A spray comprising extract of fresh fruit skins, spiny stalks and leaves of Opuntia ficus-indica, said extract comprising nutrients, minerals and active compounds and is suitable for spraying on leaves, branches and stump of plants for encouraging, rejuvenating, regenerating or enhancing growth of said plants, eliminating pathogenic effects caused by pests, parasites, insects, insect exudates, fungi and bacteria hosted by said plants and negative effects thereof and increasing potency and productivity of said plants.

26. A compost comprising soil and mixture of parts of Opuntia ficus-indica comprising fresh skins of fruits and grounded spiny stalks and leaves of said Opuntia ficus-indica, said compost is suitable for administration to plants for encouraging, rejuvenating, regenerating or enhancing growth of said plants, eliminating pathogenic effects caused by pests, parasites, insects, insect exudates, fungi and bacteria hosted by said plants and negative effects thereof and increasing potency and productivity of said plants.
